(19) United States
(12) Patent Application Publication
(10) Pub. No.: US 2013/0281653 A1
(43) Pub. Date: Oct. 24, 2013

(54) N-Heterocyclic Carbene Based Zirconium Complexes For Use In Lactones Ring Opening Polymerization

(71) Applicants: Pascal Steffanut, Village-Neuf (FR); Charles Romain, Strasbourg (FR); Samuel Dagorne, Strasbourg (FR); Stephane Bellemin-Laponnaz, Strasbourg (FR)

(72) Inventors: Pascal Steffanut, Village-Neuf (FR); Charles Romain, Strasbourg (FR); Samuel Dagorne, Strasbourg (FR); Stephane Bellemin-Laponnaz, Strasbourg (FR)

(73) Assignee: CLARIANT FINANCE (BVI) LIMITED, Tortola (VG)

(21) Appl. No.: 13/992,616

(22) PCT Filed: Dec. 5, 2011
(86) PCT No.: PCT/EP2011/006076

§ 371 Date: Jul. 10, 2013

(30) Foreign Application Priority Data
Dec. 10, 2010 (EP) 10015544.9

(51) Int. Cl. C08G 63/85

(52) U.S. Cl. CPC C08G 63/85
USPC 528/279; 548/103

(57) ABSTRACT

This invention is reporting new N-heterocyclic carbene based zirconium (or hafnium) complexes and their uses as catalysts for the lactones ring opening polymerization. These new catalysts are robust and versatile and exert control over polymer molecular weight and/or stereochemistry and exhibit high reactivity (cf. for low temperature applications). In particular the new catalysts show both enhanced activity and at the same time a better selectivity than the catalysts employed by the prior art.

In the recent years, polylactic acid (PLA) and related polymers like polycaprolactone or polybutyrolactone have been attracting attention due to their highly versatile application range and their, biodegradability. Derived from 100% renewable resources such as corn and sugar beets, PLA and related polyesters remain very interesting for the environmental protection as substitution for oil-based polymers. Nevertheless, in spite of its excellent balance of properties, the commercial use has historically been limited by high production costs as well as poorer performance profile compared to the polyolefinic equivalents. Until now, PLA has only enjoyed limited success in replacing petroleum-based plastics in commodity applications, with most initial uses limited to biomedical applications such as sutures.

Anyway, recent advances in process development, driven now by major companies (Technische biopolymere, Hans-Josef Endres and Andrea Siebert-Raths, ISBN 978-3-446-41683-3, (2009)), will lead to a significant reduction of production costs and make PLA a viable large-volume plastic for the future.

PLA can be prepared by both direct condensation of lactic acid and by the ring-opening polymerization of the cyclic lactide dimer. Because the direct condensation route is an equilibrium reaction, difficulties removing trace amounts of water in the late stages of polymerization generally limit the ultimate molecular weight achievable by this approach.

Most work has up to now focused on the ring-opening polymerization, although Mitsui Toatsu Chemicals has patented an azeotropic distillation process using a high-boiling solvent to drive the removal of water in the direct esterification process to obtain high molecular weight PLA (U.S. Pat. No. 5,194,473. Mitsui Toatsu, (1990)).

Cargill Dow LLC has developed a low-cost continuous process for the production of lactic acid-based polymers. The process combines the substantial environmental and economic benefits of synthesizing both lactide and PLA in the melt rather than in solution (U.S. Pat. No. 5,258,488 and related. Cargill, Inc. (1993)). The process starts with a continuous condensation reaction of aqueous lactic acid to produce low molecular weight PLA pre-polymer.

Next, the pre-polymer is converted into a mixture of lactide stereoisomers using tin catalysis to enhance the rate and selectivity of the intramolecular cyclization reaction. The molten lactide mixture is then purified by vacuum distillation. Finally, PLA high molecular-weight polymer is produced using a tin-catalyzed, ring-opening lactide polymerization in the melt, completely eliminating the use of costly and environmentally unfriendly solvents.

The disadvantages of the processes known from the prior art are in particular that several steps are needed, since a further purification step by vacuum distillation is required in order to separate the rac and meso lactide, which is not only time but also energy consuming.

The polymerization of lactide using tin octanoate is generally thought to occur via a coordination-insertion mechanism with ring opening of the lactide to add two lactic acid molecules to the growing end of the polymer chain. High molecular weight polymer, good reaction rate, and low levels of racemization are usually observed with tin octanoate-catalyzed polymerization of lactide.

Typical conditions for polymerization are 180±210° C., tin octoate concentrations of 100±1000 ppm, and 2±5 h to reach ca. 95% conversion. The polymerization is first order in both catalyst and lactide. Frequently hydroxyl-containing initiators such as 1-octanol are used to both control molecular weight and accelerate the reaction. Copolymers of lactide with other cyclic monomers such as caprolactone can be prepared using similar reaction conditions. These monomers can be used to prepare random copolymers or block polymers because of the end growth polymerization mechanism.

Even though the octanoate-catalyzed polymerization leads to good conversion rates, the toxicity and presence of tin in natural product based polymers cannot be disregarded. Moreover, the process requires relatively high temperatures.

A common side reaction in polyester synthesis is trans-esterification, in which cleavage and reformation of polymer chains leads to a broadening of the molecular weight distribution that has been described theoretically as a function of the monomer conversion. The degree of trans-esterification is an important selectivity criterion for any LA polymerization system. Minimal trans-esterification is especially desired in the preparation of discrete A-B block copolyesters where trans-esterification would compromise the architectural integrity of the copolymer. The occurrence of transesterification may become particularly problematic for more active, and thus less selective, polymerization catalysts. Stereoselectivity in the polymerization of LA, which exists as three stereoisomers, also is important to control since the material properties depend strongly on the polymer tacticity. As long as the polymerization catalyst does not affect epimerization of chiral centers in the monomer or polymer, isotactic PLA (PDLA or PLLA) can be accessed by using pure D- or L-LA, respectively.

Selectivity issues are more important for the polymerization of D/L-LA mixtures, where a propagating metal alkoxide center may show a preference for enchaining a particular stereoisomer. Isotactic polymer segments result from such a stereoelective reaction. Given some of the general experimental criteria for a well-behaved LA polymerization, attributes of an ideal catalyst include high activity, fast initiation relative to propagation, minimal trans-esterification, and the ability to control the stereochemical purity of the PLA prepared from an arbitrary mixture of LA stereoisomers. Systematic deconvolution of structure/activity relationships in well defined catalytic systems is important for the design of polymerization catalysts with these beneficial features.

Ligand design for homogeneous catalysis is based on the exploitation of the specific binding properties of the ligating units to the metal centres and the targeting of a particular, well defined molecular shape. It relies on the combination of the steric and electronic properties of the molecular building blocks of which a polydentate ligand system is composed. This approach is frequently employed in the development of novel molecular catalysts.

N-heterocyclic carbenes have emerged as a new family of ligands for the development of homogeneous catalysts. They are strong ó-donors through the NCN carbon bond and are now used widely as phosphine analogs. The M-C bond they form with most late transition metals has proved to be kinetically inert, thus rendering them a priviledged motif for ligand design. In contrast, the use of NHC ligands with early transition metals is occasional in part because of the ease of dissociation of the N-heterocyclic ligand from the high oxidation state transition metal. This assumption renders the chemistry of early transition metals and NHC more difficult to study. Therefore, in order to reduce the tendency for ligand dissociation, potentially bidentate or tridentate NHC donor systems that incorporate a neutral carbene donor surrounded by anionic ligands have appeared as promising ancillary ligands.

The objective of this invention is to develop new N-heterocyclic carbene based zirconium (or hafnium) complexes and their uses as catalysts for the lactones ring opening polymerization. The new catalysts are robust and versatile and exert control over polymer molecular weight and/or stereochemistry and exhibit high reactivity (cf. for low temperature applications). In particular the new catalysts show both enhanced activity and at the same time a better selectivity than the catalysts employed by the prior art. Because the physical properties of a polymeric material are tied directly to its molecular weight, control of polymer molecular weight is of great importance in the instant synthetic procedure.

Surprisingly it has now been found, that, with specific di(hydroxyaryl-substituted) N-heterocyclic carbene ligands potentially tridentate ([L,X2]-type chelate), a new series of zirconium (or hanium) complexes incorporating these ligands are among the most efficient and selective compounds for catalysing cyclic esters (lactides, á-caprolactone) ring opening polymerization. More surprisingly, they outstand the performances (selectivity, turnover) of the equivalent titanium-based complexes reported elsewhere (Zelikoff, Ayellet L.; Kopilov, Jacob; Goldberg, Israel; Coates, Geoffrey W.; Kol, Moshe. Chem. Com., (2009), (44), 6804-6806; Romain, Charles; Brelot, Lydia; Bellemin-Laponnaz, Stephane; Dagorne, Samuel. Organometallics (2010), 29(5), 1191-1198) and show a higher stability and robustness under ring opening polymerization conditions

The present invention therefore relates to N-heterocyclic carbene based zirconium (or hafnium) complexes and their uses as catalysts for the lactones ring opening polymerization.

More particularly, the invention relates to a catalytic process to obtain polyesters based on lactide, caprolactone as main monomer units by using N-heterocyclic carbene based zirconium or hafnium complexes described here.

In the following text “halogen” represents F, Cl, Br or I, preferably F, Cl or Br, more preferably F or Cl, even more preferably Cl, if not otherwise stated; “alkyl” represents linear and branched alkyl; and “alkoxy” represents linear and branched alkoxy; any alkyl and cycloalkyl groups being unsubstituted or substituted by halogen; if not otherwise stated.

The present invention is directed to a compound of formula (I)

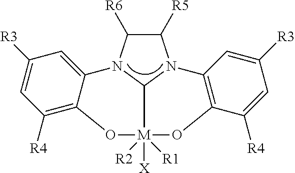

wherein
M is selected fom Zr or Hf.
R1 is selected from halogen (Cl, Br, F, I), C₁-C₁₀ Alkyl, C₁-C₁₀ alkoxy, aryl, benzyl (Bn), aryloxy, benzyloxy or amide of the formula N(R7)(R8).
R2 is optional and is a coordinative solvent e.g. tetrahydrofurane, diethylether, water, acetonitrile, dimethylamine or other weakly coordinating ligands.
X is selected from halogen (Cl, Br, F, I), C₁-C₁₀ Alkyl, C₁-C₁₀ alkoxy, aryl, benzyl (Bn), aryloxy, benzyloxy or amide of the formula N(R7)(R8).
R3 and R4 are independently from each other selected from the group consisting of hydrogen, C₁-C₁₀ alkyl, C₅-C₁₀ cycloalkyl, the alkyl groups being optionally substituted by halogen (Cl, Br, F, I); C₁-C₁₀ alkoxy, unsubstituted phenyl or substituted phenyl (with substituents being halogen, C₁-C₁₀ alkyl or nitro),
R5 and R6 are independently from each other selected from the group consisting of hydrogen, C₁-C₁₀ alkyl, C₅-C₁₀ cycloalkyl, the alkyl groups being optionally substituted by halogen (Cl, Br, F, I); unsubstituted phenyl or substituted phenyl (with substituents being halogen, C₁-C₁₀ alkyl or nitro),
R5 and R6 may be optionally linked together to form an unsaturated or saturated 5 to 6 membered ring, wherein the cycle may have one or more chiral centers.
R7 and R8 are independently from each other selected from the group consisting of C₁-C₁₀ alkyl, C₅-C₁₀ cycloalkyl, unsubstituted phenyl or substituted phenyl (with substituents being halogen, C₁-C₁₀ alkyl or nitro).

In a preferred aspect, the present invention is directed to a compound of formula (I)

wherein
M is selected fom Zr.
R1 is selected from Cl, Br, C₃-C₄ alkoxy, aryloxy.
R2 is optional and is a coordinative solvent e.g. tetrahydrofurane, diethylether, dimethylamine.
X is selected from Cl, Br, C₃-C₄ alkoxy, aryloxy, benzyloxy, C₄-C₅ alkyl or benzyl.
R3 and R4 are independently from each other selected from the group consisting of hydrogen, CH₃, C₂H₅, C₃H₇, C₄H₉.
R5 and R6 are independently from each other selected from the group consisting of hydrogen, CH₃, C₂H₅, C₃H₇, C₄H₉.
R5 and R6 may be optionally linked together to form an unsaturated or saturated 6 membered ring. When saturated, this cycle may have two chiral centers. Typical raw material that may be used is R,R—S,S—R,S cyclohexylenediamine.
R7 and R8 are independently from each other selected from the group consisting of C₁-C₁₀alkyl, C₅-C₁₀cycloalkyl.

Preparation of the ligands and the complexes done with zirconium and hafnium complexes supported by a chelating ligand (bidentate or tridentate) incorporating a N-heterocyclic carbene have thus far been generated via a “classical” salt metathesis route involving the reaction of the “free” carbene chelating ligand salt with MCl₄ or ClₓN(OR)₄-x (M=Zr, Hf). This method suffers however from two major drawbacks:
(i) the required generation of an often poorly stable “free” carbene prior to coordination of the chelating ligand to the metal and
(ii) the possible formation of undesired homoleptic bis-adduct complexes. Overall, these two factors may significantly lower the yield of the reaction.

In the present invention, a straightforward and high yield one step synthesis of bisphenolate-N-heterocyclic carbene group 4 complexes has been developed via an alcohol elimination pathway involving the reaction of o-hydroxyaryl-substituted imidazoliniums with Clₓ(Zr(OR)₄-x (FIG. 3). The above approach allows access to a variety of group 4 chloro and/or alkoxide derivatives.

Notably, the latter chloro complexes may also be easily converted in excellent yield to the corresponding alkyl and/or alkoxide derivatives (FIG. 5). Thus, a great variety of bisphenolate-N-heterocyclic carbene group 4 complexes are readily accessible in high yields in one or two synthetic steps starting from the imidazolinium precursors. Alternatively, as illustrated in FIG. 6 in the case of a zirconium derivative, deprotonation of the o-hydroxyaryl-substituted imidazolinium pro ligand and subsequent salt metathesis with MCl₄ may afford the corresponding metal complex albeit in lower yield than that obtained with the alcohol elimination method.

The zirconium and hafnium complexes of formula (I) are preferably prepared by reaction of a solution of one equivalent of a metal precursor, like for instance a metal alkoxide, metal amide, metal alkyl or a metal halogen precursors, with a boiling solution of one equivalent of the corresponding ligand. The precipitate is isolated following standard methods.

The solvents used in the process are preferably selected from the group consisting of C₁-C₈ alcohols, dialkyletheroxides, alkylnitriles, aromatics, dimethylformamide, N-methylpyrolidone or a mixture of these solvents. Particularily preferred are non-protic solvents like THF, toluene or halogenated solvents, like for instance dichloromethane, just to name a few.

The process is conducted at a temperature in the range from 10 to 150° C., preferably between room temperature and 140° C. The reaction mixture is then stirred at least for several minutes, up to 24 hours. The reaction time and reaction temperature are depending on the monomer and the solvent (if used). The reaction can be carried out neat.

### EXAMPLES

Unless notified, all manipulations were carried out under an inert atmosphere of dry nitrogen using standard Schlenk techniques. Solvents were purified and dried by standard methods. All reagents were commercially available and used as received. 1H and 13C NMR spectra were recorded on a Bruker Avance 300 spectrometer at 300 MHz and 75 MHz and were referenced using the residual proton solvent peak. Infrared spectra were obtained on a FT-IR Perkin Elmer 1600. Mass spectra were recorded by the “service de spectrométrie de masse de I'Université Louis Pasteur”. Elemental analysis was performed by the “service commun d'analyse élémentaire of the Strasbourg Chemistry Department”.

Ligand synthesis: N,N′-di(2-hydroxy-3,5-di-tert-butylphenyl)-4,5-dihydro-imidazolium chloride (1).

To a solution of N,N-bis(2-hydroxy-5 3,5-di-tert-butylphenyl)ethylenediamine (5.0 g, 10.7 mmol) in MeOH (150 ml) was added dropwise 2.10 ml of concentrated HCl (10M) at room temperature in the air. After complete dissolution of the white solid, the solution was evaporated under reduce pressure and dried in vacuum to yield the corresponding dihydrochloride salt. This was not isolated or characterized. Triethylorthoformate was added (50 ml) to the resulting solid and the flask was stirred at room temperature under N₂ for one day. Diethyl ether (50 ml) was added and the white solid was filtered and washed twice with diethyl ether to provide the desired product (5.22 g, 10.1 mmol, 94%). 1H NMR (300 MHz, CDCl3) ä 9.32 (s, 2H), 8.16 (s, 1H), 7.37 (d, J=2.3 Hz, 2H), 6.95 (d, J=2.4 Hz), 4.64 (s, 4H), 1.43 (s, 18H), 1.29 (s, 18H); 13C NMR (75 MHz, CDCl3) ä 158.8, 148.7, 143.1, 140.3, 125.3, 123.9, 119.7, 51.7, 35.5, 34.3, 31.1, 29.3. HRMS (ESI) m/z: found 479.3632, calcd for [C₃₁H₄₇N₂O₂]+479.3638.

N,N′-di(2-hydroxy-3,5-di-tert-butylphenyl)-octahydrobenzoimidazolium chloride (2). To a solution of N,N-bis(2-hydroxy-3,5-di-tert-butylphenyl)-trans-1,2-cyclohexanediamine (2.0 g, 3.8 mmol) in MeOH (40 ml) was added dropwise 0.8 ml of concentrated HCl (10M) at room temperature in the air. After complete dissolution of the white solid, the solution was evaporated under reduce pressure and dried in vacuum to yield the corresponding dihydrochloride salt. This was not isolated or characterized. Triethylorthoformate was added (10 ml) to the resulting solid and the flask was stirred at room temperature under N₂ for one day. Diethyl ether (20 ml) was added and the white solid was filtered and washed twice with diethyl ether to provide the desired product (1.42 g, 2.5 mmol, 66%). 1H NMR (300 MHz, CDCl₃) ä 9.31 (s, 2H), 8.33 (s, 1H), 7.36 (d, J=2.4 Hz, 2H), 6.86 (d, J=2.4 Hz, 2H), 4.59 (m, 2H), 2.3-19 (m, 4H), 1.42 (s, 18H), 1.29 (s, 18H); 13C NMR (75 MHz, CD₂Cl₂) ä 159.9, 149.1, 142.8, 141.4, 125.5, 123.3, 119.5, 70.9, 35.6, 34.3, 31.4, 29.6, 27.8, 23.9. HRMS (ESI) m/z: found 531.3949, calcd for [C₃₅H₅₁N₂O₂]+531.3951.

N,N′-di(2-hydroxy-3,5-di-tert-butylphenyl)benzoimidazolium chloride (3). To a solution of N,N′-bis(3,5-di-tert-butyl-2-hydroxyphenyl)-1,2-phenylenediamine (4.9 g, 9.5 mmol) in MeOH (50 ml) under nitrogen was added dropwise 1.9 ml of concentrated HCl (10M) at room temperature. After one hour strirring, the solid was isolated by filtration, washed with hexanes and dried (ca. 5 g of the corresponding dihydrochloride salt). Triethylorthoformate was added (50 ml) to the resulting solid and the flask was stirred at room temperature under N₂ for one day. Diethyl ether (20 ml) was added and the solid was filtered, recristallized from MeOH/diethyl ether to provide the desired product (2.1 g, 3.7 mmol, 39%). 1H NMR (300 MHz, CDCl₃) ä 9.28 (s, 2H), 9.04 (s, 1H), 7.61-7.57 (m, 4H), 7.55 (d, J=2.4 Hz, 2H), 7.15 (d, J=2.4 Hz, 2H), 1.48 (s, 18H), 1.34 (s, 18H)); 13C NMR (75 MHz, CDCl3) ä 149.3, 143.0, 141.8, 141.4, 132.4, 127.8, 126.9, 120.9, 114.5, 35.85, 34.5, 31.5, 29.6. HRMS (ESI) m/z: found 527.3637, calcd for [C₃₅H₄₇N₂O₂]+527.3638.

Zirconium and Hafnium Complexes Synthesis

LZr(Cl)(OⁱPr)(THF), L=ligand (1)

A THF solution (5 mL) of Zr(OⁱPr)₄, ⁱPrOH (752.6 mg, 1.94 mol) was added at room temperature via a pipette to a stirring THF solution (100 ml) of the imidazolium chloride salt 1 (1.0 g, 1.94 mmol). The initial colorless solution slowly turned yellow/green after addition of the zirconium reagent. The reaction mixture was stirred overnight at room temperature and evaporated to dryness to quantitatively yield L¹Zr(Cl)(OⁱPr)(THF) an yellow/green solid residue, as determined by NMR spectroscopy. If needed, a purification step could be applied by recrystalisation of THF/pentane (1/5). (1.14 g, 80% yield).

¹H NMR (300 MHz, CD₂Cl₂) δ: 7.21 (d, J=2.2 Hz, 2H, aryl-H), 6.98 (d, J=2.2 Hz, 2H, aryl-H), 4.48-4.21 (m, 4H, NCH₂), 4.18 (hept, J=6.2 Hz, 1H, OⁱPr), 3.76-3.63 (m, 4H, THF), 1.77-1.69 (m, 4H, THF), 1.56 (s, 18H, ^{t}Bu), 1.37 (s, 18H, ^{t}Bu), 0.94 (d, J=6.3 Hz, 6H, CH₃—OⁱPr). ¹³C NMR (75 MHz, CD₂Cl₂) δ: 200.0 (NCN), 149.1 (Cᵢₚₛₒ, O-aryl), 139.8 (C_{quat}, aryl), 138.2 (C_{quat}, aryl), 130.6 (C_{quat}, aryl), 119.8 (CH, aryl), 112.7 (CH, aryl), 73.9 (CH, OⁱPr), 70.2 (CH₂, THF), 48.1 (CH₂, NCH₂), 36.0 (C_{quat}, ^{t}Bu), 34.8 (C_{quat}, ^{t}Bu), 31.9 (CH₃, ^{t}Bu), 30.2 (CH₃, ^{t}Bu), 26.6 (CH₃, OⁱPr), 25.7 (CH₂, THF).

LHf(Cl)(OⁱPr)(THF), L=Ligand (1)

A THF solution (4 mL) of Hf(OⁱPr)₄, ⁱPrOH (230.5 mg, 0.485 mol) was added at room temperature via a pipette to a stirring THF solution (20 ml) of the imidazolium chloride salt 1 (250.0 mg, 0.485 mmol). The initial colorless solution slowly turned yellow/green after addition of the hafmium reagent. The reaction mixture was stirred overnight at room temperature and evaporated to dryness to give a yellow/green solid residue. Pure L¹Hf(Cl)(OⁱPr)(THF) was obtained as an yellow solid after recrystalization of the crude product from THF/pentane (1/5) (267.1 mg, 67% yield).

¹H NMR (300 MHz, CD₂Cl₂) δ: 7.22 (d, J=2.2 Hz, 2H, aryl-H), 6.97 (d, J=2.2 Hz, 2H, aryl-H), 4.46-4.22 (m, 5H, NCH₂ and OⁱPr), 3.79-3.70 (m, 4H, THF), 1.73-1.66 (m, 4H, THF), 1.55 (s, 18H, ^{t}Bu), 1.37 (s, 18H, ^{t}Bu), 0.92 (d, J=6.3 Hz, 6H, CH₃—OⁱPr). ¹³C NMR (75 MHz, CD₂Cl₂) δ: 203.7 (NCN), 149.4 (Cᵢₚₛₒ, O-aryl), 139.7 (C_{quat}, aryl), 138.9 (C_{quat}, aryl), 130.7 (C_{quat}, aryl), 119.9 (CH, aryl), 112.6 (CH, aryl), 72.8 (CH, OⁱPr), 71.5 (CH₂, THF), 48.1 (CH₂, NCH₂), 35.9 (C_{quat}, ^{t}Bu), 34.8 (C_{quat}, ^{t}Bu), 31.9 (CH₃, ^{t}Bu), 30.2 (CH₃, ^{t}Bu), 26.9 (CH₃, OⁱPr), 25.6 (CH₂, THF).

LZr(OⁱPr)₂, L=Ligand (1)

In a glove box, LiOⁱPr (2 M solution in THF, 68.2 μL, 0.136 mmol) was added at room temperature via a microsyringe to a precooled (−35° C.) THF solution (15 mL) of the chloroisopropoxy zirconium complex LZr(Cl)(OⁱPr)(THF) (100.0 mg, 0.136 mmol). The initial pale yellow solution became lighter within the course of a few minutes. The reaction mixture was allowed to warm to room temperature and stirred overnight to yield a yellow solution. Evaporation to dryness, subsequent addition of toluene and filtration of the resulting suspension through Celite on a glass frit yielded crude pale green solid after evaporation. Washing of the latter solid with pentane give LZr(OⁱPr)₂ as determined by NMR spectroscopy.

¹H NMR (300 MHz, CD₂Cl₂) δ: 7.05 (d, J=2.2 Hz, 2H, aryl-H), 6.91 (d, J=2.2 Hz, 2H, aryl-H), 4.46-4.00 (m, 6H, NCH₂ and CH—OⁱPr), 1.36 (s, 18H, ^{t}Bu), 1.29 (d, J=6.3 Hz, 6H, CH₃—OⁱPr), 1.26 (s, 18H, ^{t}Bu), 0.68 (d, J=6.3 Hz, 6H, CH₃—OⁱPr). δ: 201.8 (NCN), 151.1 (Cᵢₚₛₒ, O-aryl), 138.2 (C_{quat}, aryl), 137.7 (C_{quat}, aryl), 130.9 (C_{quat}, aryl), 119.3 (CH, aryl), 112.2 (CH, aryl), 71.8 (CH, OⁱPr), 70.2 (CH, OⁱPr), 47.9 (CH₂, NCH₂), 36.0 (C_{quat}, ^{t}Bu), 34.8 (C_{quat}, ^{t}Bu), 31.9 (CH₃, ^{t}Bu), 30.9 (CH₃, ^{t}Bu), 27.1 (CH₃, OⁱPr), 26.3 (CH₃, OⁱPr).

LZr(Cl)(NMe₂)(THF), L=Ligand (1)

A precooled THF solution (25 mL, −78° C.) of the imidazolinium chloride salt L (250.0 mg, 0.485 mmol) was added dropwise via a syringe to a THF solution (5 mL) of Zr(NMe2)4 (129.8 mg, 0.485 mmol) cooled at −78° C. The initial colorless solution slowly turned yellow/green after addition of the zirconium reagent, and then was allowed to warm to room temperature and stirred overnight. Evaporation to dryness gives a yellow/brown residue, which after recrystalization in THF/pentane (1/5) yielded pure L¹Zr(Cl)(NMe₂)(THF) as a yellow powder.

¹H NMR (300 MHz, CD₂Cl₂) δ: 7.26 (d, J=2.2 Hz, 2H, aryl-H), 7.03 (d, J=2.2 Hz, 2H, aryl-H), 4.52-4.24 (m, 4H, CH₂), 3.66-3.52 (m, 4H, THF), 2.82 (s, 6H, N—CH₃), 1.68-1.62 (m, 4H, THF), 1.60 (s, 18H, ^{t}Bu), 1.37 (s, 18H, ^{t}Bu). ¹³C NMR (75 MHz, CD₂Cl₂) δ: 202.9 (NCN), 148.2 (Cᵢₚₛₒ, O-aryl), 140.4 (C_{quat}, aryl), 138.4 (C_{quat}, aryl), 131.3 (C_{quat}, aryl), 119.9 (CH, aryl), 112.9 (CH, aryl), 70.6 (CH₂, THF), 48.2 (CH₂, NCH₂), 45.4 (CH₃, NCH₃), 36.0 (C_{quat}, ^{t}Bu), 34.9 (C_{quat}, ^{t}Bu), 31.9 (CH₃, ^{t}Bu), 30.5 (CH₃, ^{t}Bu), 25.6 (CH₂, THF).

LZr(Cl)(NMe₂)(HNMe₂), L=Ligand (1)

A precooled CH₂Cl₂ solution (25 mL, −78° C.) of the imidazolinium chloride salt L (250.0 mg, 0.485 mmol) was added dropwise via a syringe to a THF solution (5 mL) of Zr(NMe₂)₄ (129.8 mg, 0.485 mmol) cooled at −78° C. The initial colorless solution slowly turned yellow/green after addition of the zirconium reagent, and then was allowed to warm to room temperature and stirred overnight. Evaporation to dryness afforded a green residue, which after recrystalization in dichloromethane/pentane (1/5) gave pure L¹Zr(Cl)(NMe₂)(HNMe₂) as a green powder (186.4 mg, 60% yield).

¹H NMR (300 MHz, C₆D₆) δ: 7.54 (d, J=2.2 Hz, 2H, aryl-H), 6.81 (d, J=2.2 Hz, 2H, aryl-H), 3.36-3.19 (m, 4H, CH₂), 3.14 (s, 6H, N—CH₃), 1.88 (s, 18H, ^{t}Bu), 1.42 (s, 18H, ^{t}Bu), 1.69 (br, 6H, HNMe₂).

LZr(Cl)(Bn), L=Ligand (1)

A precooled toluene solution (20 mL, −35° C.) of Zr(Bn)₄ (177.0 mg, 0.388 mmol) was added dropwise via a syringe to a toluene suspension (20 mL) of the imidazolinium chloride salt L (200.0 mg, 0.388 mmol) cooled at −35° C. The initial colorless solution slowly turned yellow after addition of the hafnium reagent, and then was allowed to warm to room temperature and stirred overnight. Evaporation to dryness gives a yellow residue, which after washing with pentane yielded L¹Zr(Cl)(Bn) as a pale yellow powder.

¹H NMR (300 MHz, CD2Cl2): δ 7.30 (d, 2H, J=2.2 Hz, aryl-H), 6.93 (d, 2H, J=2.2 Hz, aryl-H), 6.65-6.45 (m, 3H, Bn), 6.28-6.17 (m, 2H, Bn), 4.26-4.00 (m, 4H, CH2), 2.89 (s, 2H, Bn), 1.66 (s, 18H, tBu), 1.39 (s, 18H, tBu). ¹³C NMR (75 MHz, CD2Cl2) 204.3 (C_{quat}, NCN), 147.3 (C_{quat}), 142.0 (C_{quat}), 138.2 (C_{quat}), 131.9 (C_{quat}), 131.7 (C_{quat}), 131.6 (CH), 128.6 (CH), 124.0 (CH), 119.8 (CH), 112.2 (CH), 62.5 (CH₂, Bn), 48.5 (CH₂, NCH₂), 36.0 (C_{quat}, tBu), 35.0 (C_{q}uat, tBu), 31.9 (CH₃, tBu), 30.3 (CH₃, tBu).

L¹Zr(Bn)₂, L=Ligand (1)

In a glove box, BnMgCl (1M solution in Et₂0, 144.0 μL, 0.144 mmol) was added at room temperature via a microsyringe to a precooled (−35° C.) toluene solution (15 mL) of the chlorobenzyl zirconium complex LZr(Cl)(Bn) (100.0 mg, 0.144 mmol). The initial pale yellow solution became cloudy within the course of a few minutes. The reaction mixture was allowed to warm to room temperature and stirred overnight. Filtration of the resulting suspension through Celite on a glass frit then evaporation to dryness yielded crude pale yellow solid. Recrystalization of the later solid in dichloromethane/pentane (1/5) gives pure L¹Zr(Bn)₂ as determined by NMR spectroscopy (78 mg, 78% yield).

¹H NMR (300 MHz, CD₂Cl₂): δ 7.27 (d, 2H, J=2.2 Hz, aryl-H), 6.92 (d, 2H, J=2.2 Hz, aryl-H), 6.83-6.74 (m, 4H, Bn), 6.72-6.64 (m, 2H, Bn), 6.62-6.55 (m, 4H, Bn), 4.10 (s, 4H, CH2), 1.94 (s, 4H, Bn), 1.66 (s, 18H, tBu), 1.39 (s, 18H, tBu). ¹³C NMR (75 MHz, CD₂Cl₂) 205.8 (C_{quat}, NCN), 148.0 (C_{quat}), 140.9 (C_{quat}), 139.0 (C_{quat}), 137.3 (C_{quat}), 131.9 (C_{quat}), 129.3 (CH), 129.0 (CH), 122.2 (CH), 119.4 (CH), 112.7 (CH), 55.0 (CH₂, Bn), 48.4 (CH₂, NCH₂), 36.1 (C_{quat}, tBu), 34.9 (C_{quat}, tBu), 31.9 (CH₃, tBu), 30.5 (CH₃, tBu).

L¹Hf(Cl)(Bn)

A precooled toluene solution (5 mL, −35° C.) of Hf(Bn)₄ (210.8 mg, 0.388 mmol) was added dropwise via a syringe to a toluene suspension (20 mL) of the imidazolinium chloride salt L (200.0 mg, 0.388 mmol) cooled at −35° C. The initial colorless solution slowly turned yellow after addition of the hafnium reagent, and then was allowed to warm to room temperature and stirred overnight. Evaporation to dryness gives a yellow residue, which after washing with pentane gives LHf(Cl)(Bn) as a pale yellow powder.

¹H NMR (300 MHz, CD₂Cl₂): δ 7.32 (d, 2H, J=2.2 Hz, aryl-H), 6.91 (d, 2H, J=2.2 Hz, aryl-H), 6.65-6.57 (m, 1H, Bn), 6.56-6.47 (m, 2H, Bn), 6.31-6.23 (m, 2H, Bn), 4.27-3.98 (m, 4H, CH₂), 2.64 (s, 2H, Bn), 1.67 (s, 18H, tBu), 1.39 (s, 18H, tBu). ¹³C NMR (75 MHz, CD₂Cl₂) 209.1 (C_{quat}, NCN), 147.8 (C_{quat}), 141.8 (C_{quat,}), 138.7 (C_{quat}), 132.4 (C_{quat}), 131.5 (C_{quat}), 131.5 (CH), 128.3 (CH), 124.0 (CH), 119.9 (CH), 112.3 (CH), 65.9 (CH₂, Bn), 48.5 (CH₂, NCH₂), 35.9 (C_{quat}, tBu), 35.0 (C_{quat}, tBu), 31.9 (CH₃, tBu), 30.3 (CH₃, tBu).

Ring Opening Polymerization (ROP) Process

General Polymerization Procedure.

A vial was charged with the Zr or Hf initiator and dissolved in solvent when required. X equivalent (X=M₀/I₀) of the monomer was then added and the reaction mixture was heated at considered temperature for the desired amount of time. Subsequent the solution was quenched with MeOH and evaporated to dryness. ¹H NMR revealed the conversion of monomer to polymer. The resulting material was investigated by NMR spectroscopy, SEC and MALDI-TOF mass spectrometry.

Stereocontroled Polymerization of rac-Lactide with LZr(Cl)(OⁱPr)(THF), L=ligand (1) as initiator:

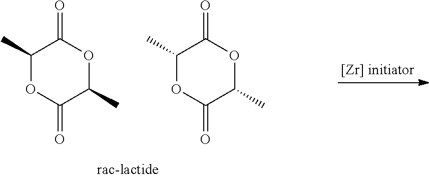

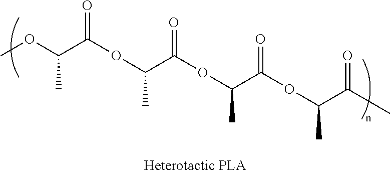

| | | | | Temp. | | | Conversion²⁾ | Mₙ³⁾ | PDI | |
|---|---|---|---|---|---|---|---|---|---|---|
| Entry | Rac-LA¹⁾ | M₀/I₀ | Solvent | (° C.) | Time | | (%) | (g/mol) | (M_{w}/Mₙ₎ | Pᵣ⁴⁾ |
| 1 | sublimed | 100 | CH₂Cl₂ | r.t. | 15 | h | 91 | 11530 | 1.06 | >0.95 |
| 2 | not purified | 100 | CH₂Cl₂ | r.t. | 15 | h | 90 | 13001 | 1.08 | >0.95 |
| 3 | sublimed | 300 | CH₂Cl₂ | r.t. | 20 | h | 84 | 36430 | 1.02 | >0.95 |
| 4 | not purified | 300 | CH₂Cl₂ | r.t. | 20 | h | 86 | 28660 | 1.03 | >0.95 |
| 5 | sublimed | 100 | neat | 130 | 3 | mn | >90 | n.d. | n.d. | 0.82 |
| 6 | sublimed | 1000 | neat | 130 | 15 | mn | 75 | 63000 | 1.4 | 0.78 |

¹⁾Mo = 1 mol/l (entry 1-4).
²⁾Determined by ¹H NMR.
³⁾Determined by gel permation chromatography (GPC) in THF, exact mass.
⁴⁾Determined by 1H homodecoupled NMR spectra;
Pᵣ is the probability of the racemic linkage.

Polymerization of β-butyrolactone and ε-caprolactone with LZr(Cl)(OⁱPr)(THF), L=ligand (1) as initiator:

| | | | | Temperature | Time | Conversion²⁾ | Mₙ³⁾ | |
|---|---|---|---|---|---|---|---|---|
| Entry | Monomere¹⁾ | M₀/I₀ | Solvent | (° C.) | (h) | (%) | (g/mol) | PDI |
| 1 | ε-CL | 100 | CH₂Cl₂ | r.t. | 15 | 70 | 7 049 | 1.11 |
| 2 | β-BL | 100 | Toluene | 90 | 15 | 100 | 8 381 | 1.09 |
| 3 | β-BL | 100 | Toluene | r.t. | 16 | 80 | n.d. | n.d. |

¹⁾M₀ = 1 mol/l.
²⁾Determined by ¹H NMR.
³⁾Determined by gel permation chromatography (GPC) in THF, exact mass

Stereocontrolled Polymerization of rac-Lactide with LHf(Cl)(OⁱPr)(THF), L=ligand (1) as initiator:

Using the general polymerization procedure, 100 equivalents of rac-lactide are polymerized in dichloromethane in 15 hours at room temperature with a conversion of ca. 75%. The Pr was found to be >0.95.

Stereocontroled Polymerization of rac-Lactide with LZr(Cl)(Bn), L=ligand (1) as initiator:

Using the general polymerization procedure, 20 equivalents of rac-lactide are polymerized in dichloromethane in 15 hours at room temperature with a complete conversion.

1. A N-heterocyclic carbene of formula (I) 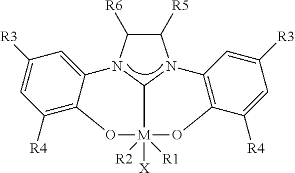
for the use as catalyst for lactone ring opening polymerization
wherein
M is Zr or Hf,
R1 is halogen, C₁-C₁₀ Alkyl, C₁-C₁₀ alkoxy, aryl, benzyl (Bn), aryloxy, benzyloxy or amide of the formula N(R7)(R8).
R2 is optional and is a coordinative solvent,
X is a halogen, C₁-C₁₀ Alkyl, C₁-C₁₀ alkoxy, aryl, benzyl (Bn), aryloxy, benzyloxy or amide of the formula N(R7)(R8),
R3 and R4 are independently from each other selected from the group consisting of hydrogen, C₁-C₁₀ alkyl, and C₅-C₁₀ cycloalkyl, the alkyl groups being optionally substituted by halogen; C₁-C₁₀ alkoxy, unsubstituted phenyl or substituted phenyl,
R5 and R6 are independently from each other selected from the group consisting of hydrogen, C₁-C₁₀ alkyl and C₅-C₁₀ cycloalkyl, the alkyl groups being optionally substituted by halogen; unsubstituted phenyl or substituted phenyl,
R5 and R6 may be optionally linked together to form an unsaturated or saturated 5 to 6 membered ring, wherein the cycle may have one or more chiral centers,
R7 and R8 are independently from each other selected from the group consisting of C₁-C₁₀ alkyl, C₅-C₁₀ cycloalkyl, unsubstituted phenyl and substituted phenyl.

2. A N-heterocyclic carbene according to claim 1, wherein
M is Zr,
R1 is Cl, Br, C₃-C₄ alkoxy or aryloxy,
R2 is optional and is a coordinative solvent,
X is Cl, Br, C₃-C₄ alkoxy, aryloxy, benzyloxy, C₄-C₅ alkyl or benzyl,
R3 and R4 are independently from each other selected from the group consisting of hydrogen, CH₃, C₂H₅, C₃H₇ and C₄H₉,
R5 and R6 are independently from each other selected from the group consisting of hydrogen, CH₃, C₂H₅, C₃H₇ and C₄H₉,
R5 and R6 are optionally linked together to form an unsaturated or saturated 6 membered ring, when saturated, this cycle optionally has two chiral centers.
R7 and R8 are independently from each other selected from the group consisting of C₁-C₁₀ alkyl, and C₅-C₁₀ cycloalkyl.

3. A process for the production of compounds of formula (I), 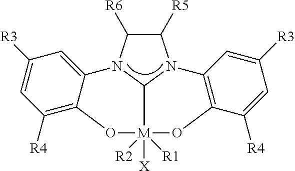
comprising the steps of reacting a solution of at least one equivalent of a Zr or Hf-metal salt with a boiling solution of one equivalent of the corresponding ligand to form a solution, and stirring the solution up to 24 hours at a temperature in the range from 10 to 150° C.

4. A process according to claim 3, wherein the solvent is selected from the group consisting of C₁-C₈ alcohols, dialkyletheroxides, alkylnitriles, aromatics, dimethylformamide, N-methylpyrolidone and mixtures thereof.

5. A N-heterocyclic carbine according to claim 1, wherein the coordinative solvent is tetrahydrofurane, diethylether, water, acetonitrile or dimethylamine.

6. A N-heterocyclic carbine according to claim 1, wherein the X is Cl, Br, F or I.

7. A N-heterocyclic carbine according to claim 1, wherein at least one of R3 and R4 is substituted by Cl, Br, F or I.

8. A N-heterocyclic carbine according to claim 1, wherein at least one of R3 and R4 is substituted by a substituted phenyl wherein the substituents are halogen, C₁-C₁₀ alkyl or nitro.

9. A N-heterocyclic carbine according to claim 1, wherein at least one of R5 and R6 is substituted by Cl, Br, F or I.

10. A N-heterocyclic carbine according to claim 1, wherein at least one of R5 and R6 is substituted by a substituted phenyl, wherein the substituents are halogen, C₁-C₁₀ alkyl or nitro.

11. A N-heterocyclic carbine according to claim 1, wherein at least one of R7 and R8 is substituted by a substituted phenyl, wherein the substituents are halogen, C₁-C₁₀ alkyl or nitro.

12. A catalytic process for the production of polyesters based on lactide, comprising the step of employing a compound of formula (I) as a catalyst 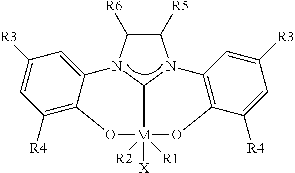
wherein
M is Zr or Hf;
R1 is selected from halogen, C₁-C₁₀ Alkyl, C₁-C₁₀ alkoxy, aryl, benzyl (Bn), aryloxy, benzyloxy or amide of the formula N(R7)(R8),
R2 is optional and is a coordinative solvent,
X is a halogen, C₁-C₁₀ Alkyl, C₁-C₁₀ alkoxy, aryl, benzyl (Bn), aryloxy, benzyloxy or amide of the formula N(R7)(R8),
R3 and R4 are independently from each other selected from the group consisting of hydrogen, C₁-C₁₀ alkyl, and C₅-C₁₀ cycloalkyl, the alkyl groups being optionally substituted by halogen; C₁-C₁₀ alkoxy, unsubstituted phenyl or substituted phenyl,
R5 and R6 are independently from each other selected from the group consisting of hydrogen, C₁-C₁₀ alkyl, C₅-C₁₀ cycloalkyl, the alkyl groups being optionally substituted by halogen; unsubstituted phenyl or substituted phenyl,
R5 and R6 are optionally linked together to form an unsaturated or saturated 5 to 6 membered ring, wherein the cycle may have one or more chiral centers,
R7 and R8 are independently from each other selected from the group consisting of C₁-C₁₀ alkyl, C₅-C₁₀ cycloalkyl, unsubstituted phenyl or substituted phenyl (with substituents being halogen, C₁-C₁₀ alkyl or nitro).

13. A process according to claim 12, wherein the coordinative solvent is tetrahydrofurane, diethylether, water, acetonitrile or dimethylamine.

14. A process according to claim 12, wherein the X is Cl, Br, F or I.

15. A process according to claim 12, wherein at least one of R3 and R4 is substituted by Cl, Br, F or I.

16. A process according to claim 12, wherein at least one of R3 and R4 is substituted by a substituted phenyl, wherein the substituents are halogen, C₁-C₁₀ alkyl or nitro.

17. A process according to claim 12, wherein at least one of R5 and R6 is substituted by Cl, Br, F or I.

18. A process according to claim 12, wherein at least one of R5 and R6 is substituted by a substituted phenyl, wherein the substituents are halogen, C₁-C₁₀ alkyl or nitro.

19. A process according to claim 1, wherein at least one of R7 and R8 is substituted by a substituted phenyl, wherein the substituents are halogen, C₁-C₁₀ alkyl or nitro.
